(19) United States
(12) Patent Application Publication
(10) Pub. No.: US 2015/0340903 A1
(43) Pub. Date: Nov. 26, 2015

(54) Systems and Methods for Power Payment Based on Proximity

(71) Applicant: Energous Corporation, Pleasanton, CA (US)

(72) Inventors: Douglas Bell, Pleasanton, CA (US); Michael Leabman, San Ramon, CA (US)

(21) Appl. No.: 14/286,232

(22) Filed: May 23, 2014

(51) Int. Cl. H02J 7/02; H02J 17/00; G06Q 30/04

(52) U.S. Cl. CPC H02J 7/025; G06Q 30/04; H02J 17/00

(57) ABSTRACT

Various exemplary embodiments of the present disclosure describe systems and methods for charging electronic devices using wireless power delivery systems. The described systems include one or more wireless power transmitters, one or more wireless power receivers and one or more electronic devices. Electronic devices may be able to communicate with wireless power transmitters and wireless power receivers using suitable communications channels. The disclosed systems are capable of associating a wireless power receiver with a customer to deliver power to a customer's device.

### BACKGROUND

1. Field of the Disclosure

The present disclosure relates in general to wireless power transmission, and more specifically to methods for delivering power to customers.

2. Background Information

Electronic devices such as laptop computers, smartphones, portable gaming devices and tablets, amongst others, may require power for performing their intended functions. This may require having to charge electronic equipment at least once a day, or in high-demand electronic devices more than once a day. Such an activity may be tedious and may represent a burden to users. For example, a user may be required to carry chargers in case his electronic equipment is lacking power. In addition, users have to find available power sources to connect to. Additionally, users may be required to plugin to a wall or other power supply to be able to charge his or her electronic device. However, such an activity may in some cases render electronic devices inoperable during charging.

For the foregoing reasons, there is a need for simple, reliable and user friendly wireless power transmission systems where electronic devices may be powered without requiring extra chargers or plugs, and where the mobility and portability of electronic devices may not be compromised.

### SUMMARY

The various exemplary embodiments presented here describe systems and methods for pairing electronic devices with wireless power receivers. The disclosed systems may include power transmitters, power receivers and electronic devices.

Power transmitters may be utilized for wireless power transmission using suitable techniques such as pocket-forming. Transmitters may be employed for sending Radio frequency (RF) signals to power receivers. Additionally, the power transmitters may be capable of keeping track of the power delivered to each electronic device within the system. Power receivers may be capable of converting RF signals into suitable electricity for powering and charging a plurality of electronic devices. Wireless power transmission may allow powering and charging a plurality of electrical devices without wires.

The presented methods may include the association of power receivers with customers to keep track of the power consumption of customers' electronic devices. The system may allow the computation of bills based on power consumption.

In some exemplary embodiments, a customer may be provided with a suitable power receiver upon request for power.

In some exemplary embodiments, a customer may be allowed to use its own power receiver within a wireless power delivery system of a commercial or retail, and the like, establishment after a suitable enrollment process.

In some exemplary embodiments, a customer may be able to purchase a predetermined amount of power.

In some exemplary embodiments, a customer may be able to have an account which provides access to wireless power delivery systems from the same service provider in more than one location.

Numerous other aspects, features and benefits of the present disclosure may be made apparent from the following detailed description taken together with the drawings provided.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows a system architecture diagram, according an exemplary embodiment;

FIG. 2 is a flowchart of a method for a method for delivering power to a customer and computing bills, according to an embodiment; and

FIG. 3 shows a flowchart of another method for delivering power to a customer and computing bills, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms may have the following definitions:

“Pairing” refers to the association of a single electronic device with a single power receiver.

Pocket-forming” may refer to generating two or more RF waves which converge in 3-D space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antennas such that focused RF signals are directed to a target.

“Receiver” may refer to a device which may include at least one antenna, at least one rectifying circuit and at least one power converter for powering or charging an electronic device using RF waves.

### Description of the Drawings

The various exemplary embodiments presented here describe systems and methods for delivering power to electronic devices.

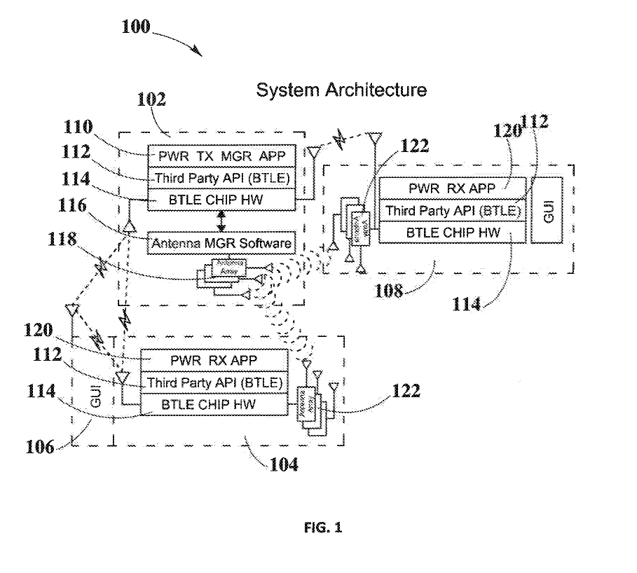

FIG. 1 shows a wireless charging system architecture 100, according to an exemplary embodiment.

System architecture 100 may include one or more wireless power transmitters 102 , and one or more wireless power receivers 104. In some embodiments, wireless charging system architecture 100 may include one or more electronic devices 106, where electronic devices 106 may not have a built-in wireless power receiver 104. In other embodiments, wireless charging system architecture 100 may include electronic devices 108 with a built-in power receiver 104.

Power transmitters 102 may transmit controlled Radio Frequency (RF) waves which may converge in 3-D space. These RF waves may be controlled through phase and/or relative amplitude adjustments to form constructive and destructive interference patterns (pocket-forming). Pockets of energy may form at constructive interference patterns that may be 3-dimensional in shape whereas null-spaces may be generated at destructive interference patterns.

According to exemplary embodiments, power transmitters 102 may include a power transmitter manager application 110, a third party BTLE API 112, a BTLE chip 114, an antenna manager software 116 and an antenna array 118 among other components. Power transmitter manager application 110 may be an executable program loaded into a non-volatile memory within a power transmitter 102. Power transmitter manager application 110 may control the behavior of power transmitter 102, monitor the state of charge of electronic devices 106, electronic devices 108 and power receivers 104, may keep track of the location of power receivers 104 and may execute power schedules, amongst others. In some embodiments, power transmitters 102 may include a database (not shown in figure) for storing information related to power receivers 104, electronic devices 106, power status, power schedules, IDs, pairing and any suitable information necessary for running the system.

Third party BTLE API 112 may enable the effective interaction between power transmitter manager application 110 and BTLE chip 114. Antenna manager software 116 may process orders from power transmitter manager application 110 and may control antenna array 118.

Antenna arrays 118 that may be included in power transmitters 102 may include a number of antenna elements capable of transmitting power. In some embodiments, antenna array 118 may include from 64 to 256 antenna elements which may be distributed in an equally spaced grid. In one embodiment, antenna array 118 may have an 8×8 grid to have a total of 64 antenna elements. In another embodiment, antenna array 118 may have a 16×16 grid to have a total of 256 antenna elements. However, the number of antenna elements may vary in relation with the desired range and power transmission capacity of power transmitter 102. Generally, with more antenna elements, a wider range and higher power transmission capacity may be achieved. Alternate configurations may also be possible including circular patterns or polygon arrangements, amongst others.

The antenna elements of antenna array 118 may include suitable antenna types for operating in frequency bands such as 900 MHz, 2.5 GHz, 5.250 GHz, or 5.8 GHz, antenna elements may operate in independent frequencies, allowing a multichannel operation of pocket-forming.

Power transmitter 102 may additionally include other suitable communications methods such as Wi-Fi, Zig bee and LAN amongst others.

Power receivers 104 may include a power receiver application 120, a third party BTLE API 112, a BTLE chip 114, and an antenna array 122. Power receivers 104 may be capable of utilizing pockets of energy produced by power transmitter 102 for charging or powering electronic devices 106 and electronic devices 108. Power receiver application 120 may be an executable program loaded into a non-volatile memory within a power receiver 104.

Third party BTLE API 112 may enable the effective interaction between power receiver application 120 and BTLE chip 114. Antenna array 122 may be capable of harvesting power from pockets of energy.

Electronic devices 106 and electronic devices 108 may include a GUI for managing their interactions within wireless charging system architecture 100. The GUI may be associated with an executable program loaded into a non-volatile memory. In some embodiments, electronic devices 106 and electronic devices 108 may include a database (not shown in figure) for storing information related to power receivers 104, power status, power schedules, IDs, pairing and any suitable information necessary for running the system.

In other exemplary embodiments, electronic devices 106 and electronic devices 108 may not include a GUI but may include embedded software that may allow electronic devices 106 and electronic devices 108 to interact with wireless charging system architecture 100.

In some embodiments, wireless charging system architecture 100 may include multiple power transmitters 102 and/or multiple power receivers 104 for charging a plurality of electronic devices 106. In systems including multiple power transmitters 102, the two or more power transmitters may be in constant communication using any suitable communication channel available, including Bluetooth, BTLE, Wi-Fi, Zig bee, LAN, LTE and LTE direct amongst others.

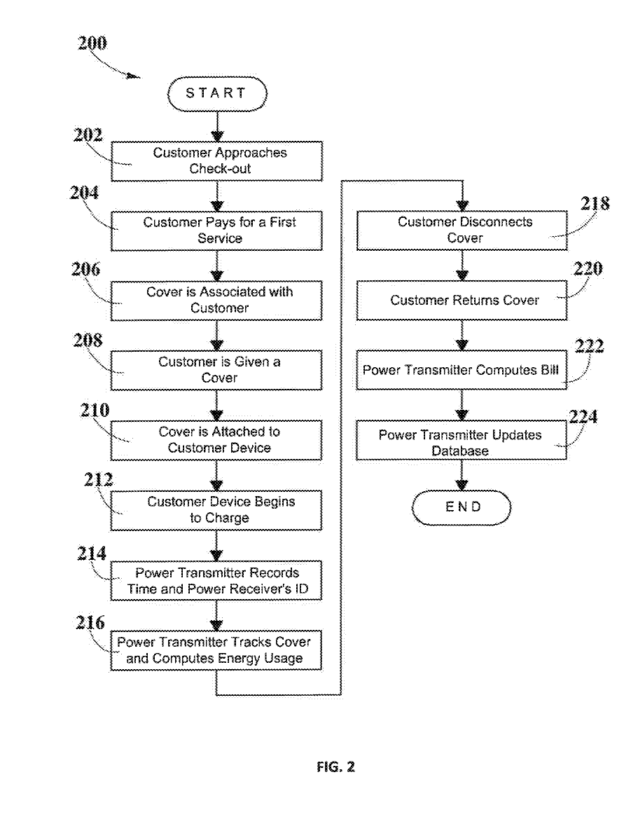

FIG. 2 is a flowchart of a power delivery and bill computing process 200, according to an exemplary embodiment. Power delivery and bill computing process 200 may start when a customer may approach 202 the checkout of a service provider or goods-selling store, where the customer may pay 204 for a first service or may purchase goods. The customer may need to charge an electronic device and may ask for power. Upon request, a cover may be associated 206 in a database with a customer. In this step any needed customer information may be stored in the database, this information may include customer number, customer ID, name, credit card number and type of customer, amongst others.

Then, the customer may be given 208 its associated cover and may attach 210 the cover to an electronic device that needs to be charged. The electronic device may then begin 212 to receive power. In some embodiments, the electronic device may receive power pre-stored in a battery included in the power receiver embedded in the attached cover. In other embodiments, the electronic device may receive power sent wirelessly by the power transmitter to the power receiver. The power transmitter may record 214 the status of the power receiver, the ID of the power receiver and the time the customer device started charging. The power transmitter may store the records in a suitable database.

While the electronic device is being charged by the power receiver, the power transmitter may track 216 the power receiver and keep a record of the power delivered to the electronic device.

When the electronic device is fully charged or the customer needs to leave the premises of the establishment, the customer may disconnect 218 the power receiver and return it 220 at the check-out. Upon request or automatically, the power transmitter may compute 222 the bill for the customer based on the amount of power delivered to the electronic device. Subsequently, the power transmitter may update 224 the database with the bill and any other suitable information and the process may end.

In some alternative embodiments, the customer's electronic device may have an embedded power receiver compatible with wireless charging system installed in the establishment. In this embodiment, the electronic device may be enrolled in the system and the customer's information may be associated with the device. In some cases, these electronic devices may be given limited permission to receive power.

In some exemplary embodiments, a customer may be able to purchase a predetermined amount of power. Additionally, it may be able to use only portions of the purchased power at a time.

In some exemplary embodiments, a customer may be able to have an account which provides access to wireless power delivery systems from the same service provider in more than one location.

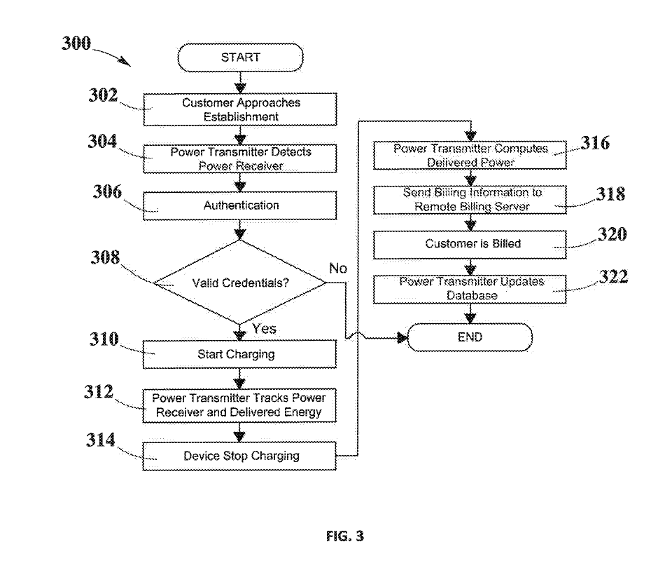

FIG. 3 is a flowchart of a power delivery and bill computing process 300, according to an exemplary embodiment. Power delivery and bill computing process 300 may start when a customer may approach 302 an establishment carrying an electronic device paired with a wireless power receiver. Then, a wireless power transmitter within the wireless power delivery system of the establishment may detect 304 the customer's power receiver and may proceed to authenticate 306 the customer's credentials. According to some embodiments, the power transmitter may use a suitable IP/TCP connection to connect to a suitable service provider server to authenticate 306 the customer's credentials.

If the credentials are not valid 308, process 300 may end. If the customer's credentials are valid 308 the power transmitter may start sending wireless power to the customer's power receiver to start charging 310 customer's electronic device.

While the electronic device is being charged by the power receiver, the power transmitter may track 312 the power receiver and keep a record of the power delivered to the electronic device.

Afterwards, when the customer wants to leave the establishment or the customer's electronic device is fully charged the wireless power transmitter may stop 314 sending wireless energy to the customer's power receiver.

Then, the power transmitter may compute 316 the amount of power delivered to the customer's electronic device and may send 318 the information to a remote billing server and the customer may be billed 320.

Subsequently, the power transmitter may update 322 the database with the bill and any other suitable information and process 300 may end.

### EXAMPLES

In example #1 a customer enters a coffee shop and buys a cup of coffee. At checkout, the costumer asks for power to charge a smartphone. The customer's smartphone includes a suitable GUI for interacting with a wireless charging system. A cover with an embedded power receiver is associated with the customer and the customer receives the cover. Then, the smartphone is paired with a power receiver embedded in the smartphone cover. The smartphone starts receiving power and the power transmitter keeps records of the time, amount of power delivered to the smartphone, position of the power receiver and any suitable information needed. After some time, the smartphone reaches a desired level of charge and the customer disconnects the power receiver and returns it to the check-out. The power transmitter computes the bill based on the amount of power delivered to the smartphone and updates the database. The customer's electronic device is charged and the process ends.

In example #2 a customer enters a coffee shop and buys a cup of coffee. At checkout, the costumer asks for power to charge a smartphone. The customer's smartphone includes a suitable GUI and a power receiver for interacting with a wireless charging system. The smartphone is enrolled in the system using Near Field Communication (NFC). The smartphone starts receiving power and the power transmitter keeps records of the time, amount of power delivered to the smartphone, position of the power receiver and any suitable information needed. After some time, the smartphone reaches a desired level of charge and the customer returns to the check-out. The database is updated and the smartphone's permission to receive power is cancelled. The power transmitter computes the bill based on the amount of power delivered to the smartphone and updates the database. The customer's electronic device is charged and the process ends.

In example #3 a customer enters a coffee shop and buys a cup of coffee. The customer carries a smartphone paired with its own power receiver. A wireless power transmitter in the coffee shop detects the power receiver within the customer's smartphone. The power receiver reads the power receiver's unique identifier and using the coffee shop's network connects to a remote billing server to authenticate the unique ID of the power receiver. The device is authorized to receive wireless power and the power transmitter start delivering wireless energy to the smartphone. The power transmitter keeps records of the time, amount of power delivered to the smartphone, position of the power receiver and any suitable information needed. After some time, the customer leaves the establishment and the power transmitter computes the amount of energy delivered to the smartphone. The information is sent to a remote billing server, the customer is billed and the power transmitter updates its database.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. An apparatus for wirelessly providing power, comprising:
a wireless power transmitter ;
a wireless power transmitter manager, configured to control radio frequency (RF) waves to form three-dimensional pockets of energy for providing power from the wireless power transmitter to a receiver; and
an interface for determining at least one of (i) the amount of power provided by the wireless power transmitter and (ii) a time period of power being provided by the wireless power transmitter,
wherein the interface is configured to communicate with the wireless power transmitter manager to calculate a billing amount based on the determination.

2. The apparatus of claim 1, wherein the wireless power transmitter manager is configured to control RF waves via at least one of phase and relative amplitude adjustments to form constructive and destructive interference patterns.

3. The apparatus of claim 1, wherein the wireless power transmitter comprises an antenna array comprising a plurality of antenna elements.

4. The apparatus of claim 1, wherein the interface is configured to determine a total amount of power provided by the wireless power transmitter.

5. The apparatus of claim 1, wherein the interface is configured to communicate with the wireless power transmitter to provide a predetermined amount of power.

6. The apparatus of claim 1, wherein the wireless power transmitter manager is configured to determine an authorization for the receiver and provide power to the receiver when the authorization is valid.

7. The apparatus of claim 1, further comprising communications for communicating over a computer network, the apparatus being configured to receive information regarding the receiver via the communications.

8. A method for wirelessly providing power via an apparatus, comprising:
controlling radio frequency (RF) waves in a wireless power transmitter of the apparatus, via a wireless power transmitter manager, to form three-dimensional pockets of energy for providing power from the wireless power transmitter to a receiver;
determining, via an apparatus interface, at least one of (i) the amount of power provided by the wireless power transmitter and (ii) a time period of power being provided by the wireless power transmitter; and
calculate a billing amount based on the determination.

9. The method of claim 8, wherein the step of controlling RF waves comprises adjusting at least one of phase and relative amplitude to form constructive and destructive interference patterns.

10. The method of claim 8, wherein the wireless power transmitter comprises an antenna array comprising a plurality of antenna elements.

11. The method of claim 8, further comprising the step of determining a total amount of power provided by the wireless power transmitter.

12. The method of claim 8, further comprising the step of specifying to the wireless power transmitter via the interface a predetermined amount of power to be provided.

13. The method of claim 8, further comprising the steps of determining, via the wireless power transmitter manager, an authorization for the receiver and providing power to the receiver when the authorization is valid.

14. The method of claim 8, further comprising the step of receiving, via communications in the apparatus, information regarding the receiver.

15. A system for wirelessly providing power, comprising:
a wireless power transmitter ;
a wireless power transmitter manager, configured to control radio frequency (RF) waves to form three-dimensional pockets of energy for providing power from the wireless power transmitter to a receiver;
communications for receiving information regarding the receiver; and
an interface for determining at least one of (i) the amount of power provided by the wireless power transmitter cased on the received information and (ii) a time period of power being provided by the wireless power transmitter, wherein the interface is configured to communicate with the wireless power transmitter manager to calculate a billing amount based on the determination.

16. The system of claim 15, wherein the wireless power transmitter manager is configured to control RF waves via at least one of phase and relative amplitude adjustments to form constructive and destructive interference patterns.

17. The system of claim 15, wherein the wireless power transmitter comprises an antenna array comprising a plurality of antenna elements.

18. The system of claim 15, wherein the interface is configured to determine a total amount of power provided by the wireless power transmitter.

19. The system of claim 15, wherein the interface is configured to communicate with the wireless power transmitter to provide a predetermined amount of power.

20. The system of claim 15, wherein the wireless power transmitter manager is configured to determine an authorization for the receiver based on the received information and provide power to the receiver when the authorization is valid.
